(19) United States
(12) Patent Application Publication
(10) Pub. No.: US 2004/0147267 A1
(43) Pub. Date: Jul. 29, 2004

(54) Wireless communications network

(76) Inventors: Stephen Hill, Subiaco (AU); Steven Kenny, Subiaco (AU); Dickson Poon, Subiaco (AU); David Parsons, Subiaco (AU)

Correspondence Address: Michael D Bednarek, Shaw Pittman, 1650 Tyson Boulevard, McLean, VA, 22102, US

(21) Appl. No.: 10/473,066

(22) PCT Filed: Mar. 28, 2002
(86) PCT No.: PCT/AU02/00395

(30) Foreign Application Priority Data
Mar. 28, 2001 (AU) PR 4055
Mar. 28, 2001 (AU) PR 4057
Mar. 28, 2001 (AU) PR 4058

(51) Int. Cl. H04B 7/005; H04B 7/01; H04B 7/015

(52) U.S. Cl. 455/456.1; 455/456.2

(57) ABSTRACT

A wireless telecommunications network (100) comprises a multiplicity of Bluetooth™ units, some of which are fixed and act as base units (BS1; BS2; BS3; BS4) and some mobile (MS1; MS2; MS3; MS4). The fixed units are connected to a Local Area Network (LAN) along with a telephony gateway (4) and a PABX (5) and PSTN (6). Methods for controlling handoff of mobile units while roaming within the network are provided, as well a method for determining the order of handoffs and the positions of mobile positions within the network.

### FIELD OF THE INVENTION

The present invention relates to a wireless communications network and, in particular systems and methods for determining a mobile terminal position in such a wireless network, as well as for performing Handoff between mobile terminals, and for determining the order of handoffs i.e. handoff sequencing particularly, although not exclusively, in a wireless network of Bluetooth™ devices.

### BACKGROUND ART

Personal productivity devices such as mobile phones, laptop computers, personal digital assistants (PDAs) and headsets have traditionally been connected together by cables. The major shortcomings of this approach include the number of cables to be carried around and the difficulties of getting compatible connections between devices from different vendors.

New wireless technologies have emerged recently that allow these devices to interwork without cables. These technologies are specifically designed to provide a very cost effective, standardised solution for an individual's devices to interwork within their “personal space”. They are short range, they carry multimedia information content, they are standardised and they deliver a “Personal Area Network” (PAN).

The PAN provides a useful solution for an individual and his personal devices. A logical extension to this model is for one member of the PAN to be a laptop or PC that is connected to a corporate Local Area Network (LAN). Extending this concept to an office environment leads to the conclusion that there will be many PANs in an office; in the extreme each office worker will have an individual PAN with a LAN connection.

Such a managed group of PANs is described as a “meta-PAN”. A meta-PAN allows the individual personal productivity devices to be integrated into the enterprise information systems. This integration is achieved by applying policies to manage, for example, radio interference between PANs, security and access control of devices, coverage, capacity and connectivity to central services.

One such wireless standard that has been developed is the Bluetooth™ standard developed by a consortium of parties and intended to achieve interoperability between different wireless devices—even if produced by different manufacturers. Bluetooth is know to persons skilled in the art and therefore need not be described in full detail herein. For further details, the addressee is directed to the Bluetooth Specifications provided by the Bluetooth Special Interest Group.

Summarised below are the main aspects relating to Bluetooth.

Bluetooth devices are radio-based devices, and are designed to operate within PANs of, typically, cell radii ranging from less than 10 m to more than 100 m in ideal conditions. The majority of battery-powered devices are likely to operate with a 10-20 m cell radius.

Bluetooth devices operate in a frequency band of between 2.4 and 2.5 GHz with a transmitting power of between 1 and 100 mW. The maximum bit rate at which data is transferred is 1 Mbit/s although this is effectively lower, but has been estimated as being up to 721 kbits/s.

In Bluetooth there are a number of defined profiles and usage models. A usage model describes a number of user scenarios—such as file transfer, dial-up networking, LAN access, synchronisation, telephone to service provider connection, and the use of a wireless headset acting as a remote audio input/output device. A profile defines options in each protocol that are mandatory for that profile, as well as parameter ranges for each protocol.

There are a number of Bluetooth profiles, and these are set out in the Bluetooth Specification as set out by the Bluetooth Special Interest Group. These profiles include: Generic Access Profile, (GAP), service Discovery Application Profile, (SDAP), Serial Port Profile, and Generic Object Exchange Profile (GOEP).

There are a number of core Bluetooth protocols:

Baseband—which enables the physical Radio-frequency (RF) link between bluetooth devices, and controls the Bluetooth devices' synchronisation and frequency hopping sequence (discussed below). There are two different links—Synchronous Connection Oriented (SCO)— mainly for audio, and Asynchronous Connectionless (ACL)— mainly for data. The two links can be multiplexed to use the same RF link.

Host Controller Interface (HCI)— provides an interface for accessing hardware capabilities, a command interface to the Baseband Controller and Link Manager, and contains control and event registers.

Link Manager Protocol (LMP)— which is responsible for the link set-up between bluetooth devices, power management, and authentication and encryption.

Logical Link Control and Adaptation Protocol (L2CAP)— provides connection-oriented and connectionless data services, such as multiplexing, segmentation and reassembly of data packets, as well as “quality of service” information between bluetooth devices.

Service Discovery protocol, SDP—allows for discovery of new services available.

RFCOMM—is a serial port emulation protocol.

Telephony Control Specification (TCS)— defines control signalling for the establishment of speech and data calls between Bluetooth devices.

There are also a number of adopted protocols, including PPP, TCP/UDP/IP, Obex, and WAP.

These adopted protocols are well known to persons skilled in the art, and need not be described in any further detail herein.

A Bluetooth piconet can include up to eight separate bluetooth devices. When Bluetooth devices are communicating, one is defined as the “Master” and the rest are defined as “Slaves”. The master unit has a system clock and identity that are central to the operation of the frequency hopping. This is well known to persons skilled in the art, and need not be described in any further details herein.

Bluetooth uses a frequency hopping technique to avoid interference between RF transmissions. In this technique, the frequency band is divided into a number of hop channels; with a different hop channel being used every 625 μs time slot i.e. at a rate of 1600 hops per second. Every hop channel is a fraction of the total frequency band. The hop from one channel to another is affected in a pseudo-random order.

Gaussian shaped binary Frequency Shift Key modulation is used, and full duplex transmission is achieved using time division multiplexing wherein subsequent slots are used for transmission and reception. The baseband protocol is a combination of circuit and packet switching. Data is sent in packets—each packet being sent within one time slot. Each packet includes a 72-bit access code, then a 54-bit header code, and followed by the data file/payload of anything from zero to 2745 bits i.e. up to 340 bytes. The access code is based on the identity of the master, and it's system clock.

Any two bluetooth devices can set up an ad-hoc connection, which is called a Piconet. As mentioned above, a piconet can include up to eight bluetooth devices, of which one is the master, and the other are slaves. There is no difference between bluetooth units in terms of the hardware and software that determines their roles, and, therefore, any Bluetooth device can be a master, and any can be a slave. The device that establishes the piconet is the master, and roles within a piconet can be changed, so that a slave can become a master and vice versa. The master unit controls all traffic in the piconet, and allocates capacity for SCO and polling for ACL links. Every slave unit is addressed in a specific order and polling scheme. Slave units can only transmit in response to an address from the master in the preceding time slot. If no information is sent to the master in response to being addressed, then a packet including only the access code and header is sent.

Before joining a piconet, a bluetooth device is in standby, in which the unit periodically “listens” for paging messages—every 1.28 seconds. These paging messages are transmitted on hop carriers known as “wake-up” carriers. The wake-up sequence is transmitted by the master on the wake-up carriers. The slave listens for 18 slots on the wake-up carrier and compares the incoming signal with the access code derived from its own identity, and, if there is a match, the slave invokes a set-up procedure and enters a Connected Mode. The correct access code and wake-up sequence are calculated using the specific slave's identity and system clock. To keep track of the slaves' system clocks, a paging procedure is defined for the master.

If multiple piconets cover the same area, a unit can participate in two or more overlaying piconets by applying time multiplexing. To participate on the proper channel, it should use the associated master device address and proper clock offset to obtain the correct phase. A Bluetooth unit can act as a slave in several piconets, but only as a master in a single piconet: since two piconets with the same master are synchronized and use the same hopping sequence, they are one and the same piconet. A group of piconets in which connections exists between different piconets is called a scatternet.

It is common for some Bluetooth devices to be mobile units, which will move about the network. For example, an individual may take his mobile phone and or PDA with him when he walks down the corridor to attend a meeting in another office. Once in the other office, he may wish to retrieve his emails, which will require that his mobile phone or PDA be able to communicate with a local base unit—commonly referred to as a Base Station (BS). This is called roaming, and the idea of roaming is well known in the field of cellular radio telecommunications. When a mobile unit (commonly referred to as Mobile station (MS)) is in communication with a Base Station, and the Mobile Station is actually moving, it may be necessary—because the Mobile Station moves away from the Base Station and the signal between the two becomes too weak to enable acceptable communication—to transfer the communication link from the Mobile Station to another Base Station with better link quality. Transferring a Mobile Station from a serving Base Station to a new Base Station is called “Handoff”. At present, there is no existing technique for performing handoff over Bluetooth.

### DISCLOSURE OF THE INVENTION

According to a first aspect of the present invention, there is provided a method for determining information regarding a mobile terminal's movement within a wireless network including a plurality of fixed and mobile terminals, the method comprising the steps of: measuring synchronised Received Signal Strength Information (RSSI) measurements at, at least, two different points in time from at least three fixed terminals for a mobile terminal moving within the network; interpolating the synchronised measurements to provide an estimate of the distance of the mobile terminal, from each of the at least three fixed terminals, at each different point in time; determining an estimated position of the mobile terminal, at each different point in time, from the estimated distances of the mobile terminal from each of the fixed terminals; and determining the mobile terminal velocity by dividing the distance between the positions of the mobile terminal at the two different points in time by the time interval between the two different points in time.

The estimated position may be determined by triangulation.

The method may further include the step of carrying out a plurality of determinations of the estimated position of the mobile terminal and applying a non-linear least squares fit algorithm to the triangulation step.

The non-linear least squares fit algorithm may include the step of deriving the sum of squares error function and determines the mobile terminal position that minimises that function.

The method may further include the steps of defining a residual error for the mobile terminal and each fixed terminal, the residual error being defined as the value of the absolute difference between the distance estimate and the calculated distance using the co-ordinates of the fixed terminal and the mobile terminal estimates, determining any residual error values having a value greater than a predetermined level removing any RSSI measurements between the mobile terminal and a fixed terminal within a predefined radius of a location where the residual error values are greater than the predetermined value, from future calculations.

The method may further include the step of determining the direction of travel of the mobile terminal.

A method as claimed in any preceding claim, wherein the method further includes the step of building a map of mobile terminal movement within the network environment.

According to a second aspect of the present invention, there is provided a wireless network comprising a plurality of fixed terminals in communication with one or more mobile terminals roaming within the network, the network including control means operable to determine the velocity of a mobile terminal by measuring synchronised Received Signal Strength Information (RSSI) measurements for the mobile terminal from at least three fixed terminals at at least two different points in time; to interpolate the measurements to provide an estimate of the distance of the mobile terminal from each of the at least three fixed terminals at each different point in time; to estimate a position of the mobile terminal, at each different point in time, from the estimated distances of the mobile terminal from the at least three fixed terminal; and to determine the velocity of the mobile terminal by dividing the distance between the positions of the mobile terminal at the two different points in time by the time interval between the two different points in time.

The control means may be operable to estimate the mobile terminal position using triangulation.

The control means may be further operable to provide a plurality of determinations of the estimated position of the mobile terminal and to apply a non-linear least squares fit algorithm to the triangulation step.

The non-linear least squares fit algorithm may include the step of deriving the sum of squares error function and determines the mobile terminal position that minimises that function.

The control means may be further operable to define a residual error for the mobile terminal and each base terminal as the value of the absolute difference between the distance estimate between two terminals and the calculated distance using the co-ordinates of the fixed terminal and the mobile terminal estimates, to determine if any residual error values have a value greater than a predetermined level; and to remove any RSSI measurements between the mobile terminal and a fixed terminal within a predefined radius of a location where the residual error values are greater than the predetermined value, from future calculations.

The control means may be further operable to determine, on the basis of the measurements, the direction of movement of the mobile terminal within the network.

The control means may be further operable to build up a map of the mobile terminal movement within the wireless network environment from the velocity and direction of travel information.

The control means may include storage means for storage of the velocity and direction of travel information therein.

This invention has the advantage that it maintains real time information about the position and velocity of all terminals in the system. It uses this information to identify behavioural patterns for each terminal that allows the system to predict where the terminal will move. These predictions are used to reduce the average number of handoffs required, as well as other services that are position dependent.

According to a third aspect of the present invention, there is provided a wireless network comprising a plurality of terminals, the terminals being operable within the network as either master or slave units, and within the network there is provided first second and third terminals in which the first and second terminals are in communication with each other in a first piconet whereby the first terminal is a master unit and the second terminal is a slave unit, the terminals being operable to control a switch in communication between the second and first terminals to communication between the second and third terminals in a second piconet.

The first and third terminals may be operable to communicate with each other to request and agree transfer of communication between the first and second terminals to communication between second and third terminals, to communicate information regarding the first piconet, and the second terminal, to the third terminal, the third terminal being further operable, upon receipt of the information and agreement to accept the second terminal into the second piconet, to temporarily assume the role of master of the first piconet to enable communication with the second terminal and to provide information regarding the second piconet to the second terminal, the second terminal being operable, in response to the second piconet information to respond to the third terminal and to communicate therewith to transfer the second terminal into the second piconet.

Communication between the first and second terminals may be suspended during transfer of the second terminal to the second piconet.

The network may be a network of Bluetooth™ units.

According to yet another aspect of the present invention, there is provided a method for performing handoff from a first terminal in communication with a second terminal, to a third terminal in a wireless communications network comprising a plurality of terminals, the terminals being operable within the network as either master or slave units, and within the network there is provided the first second and third terminals in which the first and second terminals are in communication with each other in a first piconet whereby the first terminal is a master unit and the second terminal is a slave unit, the method including the step of controlling a switch in communication between the second and first terminals to communication between the second and third terminals in a second piconet.

The method may further include the steps of the first and third terminals communicating with each other to request and agree transfer of communication between the first and second terminals to communication between second and third terminals, and to communicate information regarding the first piconet, and the second terminal, to the third terminal; the third terminal temporarily assuming the role of master of the first piconet to enable communication with the second terminal and providing information regarding the second piconet to the second terminal, upon receipt of the information and agreement to accept the second terminal into the second piconet; and the second terminal responding, in response to the second piconet information, to the third terminal and to communicate therewith, to transfer the second terminal into the second piconet.

Communication between the first and second terminals may be suspended during transfer of the second terminal to the second piconet.

The method may include the step of determining the third terminal from the terminals in the wireless network.

Until the present invention, switching communication from one fixed terminal to another has not been possible with networks comprising Bluetooth units. This invention, allows this switching—or “Handoff”—and so allows continuous communication even while the mobile terminal is moving within the network.

According to yet another aspect of the present invention, there is provided method for determining handoff sequencing within a wireless network comprising a plurality of fixed terminals in wireless communication with one or more mobile terminals roaming within the network, the method including the steps of:

determining the probable paths of the mobile terminals within the network;

determining a set of fixed terminals within the network to which the mobile terminals could be in communication therewith;

creating a first bipartite graph with the set of fixed and mobile terminals;

applying weightings to the edges of the first bipartite graph in accordance with predetermined parameters to create a weighted bipartite graph;

solving an optimal assignment problem for the weighted bipartite graph to derive a second graph having a second set of edges, to determine a new set of connections between mobile and fixed terminals; and

further comprising the step of comparing the first and second bipartite graphs, whereby edges not in the first graph represent communications links that should be made, and edges in the first, but not in the second, represent communications links that need to be broken.

The predetermined parameters may include providing high weightings for active connections that should not be broken unless required to allow all mobile terminals to be connected, and low weightings for connections requiring handoff.

A further predetermined parameter may be the probable path that a mobile terminal may take within the network. The probable path is determined by historical data, or by its velocity.

A further predetermined parameter may be the number of fixed terminals to be used.

According to yet another aspect of the present invention, there is provided a network comprising a plurality of fixed terminals in wireless communication with one or more mobile terminals roaming within the network, the network including a control means operable to determine the probable paths of the mobile terminals within the network, and a set of fixed terminals within the network to which the mobile terminals could be in communication therewith, the control means being further operable to create a first bipartite graph with the set of fixed and mobile terminals, to apply weightings to the edges of the first bipartite graph in accordance with predetermined parameters to create a weighted bipartite graph, and to solve an optimal assignment problem for the weighted bipartite graph to derive a second graph having a second set of edges, to determine a new set of connections between mobile and fixed terminals.

The control means may be further operable to compare the first and second bipartite graphs, such that edges not in the first graph represent communications links that should be made, and edges in the first, but not in the second, represent communications links that need to be broken.

The predetermined parameters may include providing high weightings for active connections that should not be broken unless required to allow all mobile terminals to be connected, and low weightings for connections requiring handoff.

A further predetermined parameter may be the probable path that a mobile terminal may take within the network. The probable path may be determined by historical data, or by its velocity.

A further predetermined parameter may be the number of fixed terminals to be used.

The present invention allows the Base Stations that can be used for handoff to be determined, without requiring that the position of the mobile stations be determined with any great accuracy.

### BRIEF DESCRIPTION OF THE DRAWINGS

The invention will now be described, by way of example only, with reference to the accompanying drawings, of which:

FIG. 1 is a schematic illustration of a network comprising a plurality of wireless units in a small environment;

FIG. 2 is a schematic illustration of the components of a wireless network;

FIG. 3 is a schematic illustration of the components of a network controller for the network of FIG. 2;

FIG. 4 is a schematic illustration of the components of Bluetooth base station units used in the present invention;

FIG. 5 is a schematic illustration of the handoff routine as performed in the embodiment described herein;

FIG. 6 is a schematic illustration of a network environment—divided into a grid for the purposes of the present invention;

FIG. 7 is a diagram illustrating Step 3 in the method for determining the weighting function, for use in identifying a suitable base station for a handoff process; and

FIGS. 8A to 8E are bipartite graphs used in determining handoff sequencing when two Base Stations are operating at full capacity.

### BEST MODE(S) FOR CARRYING OUT THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In the present specification the term “fixed” is used in relation to terminals. In the present specification, this term is used to define a terminal that is fixed, at any one time, in relation to the mobile terminals. It should be understood that these fixed terminals are not permanently fixed at any one location and can be moved—indeed may often be moved within a network environment. This term should therefore not be construed in a limiting form.

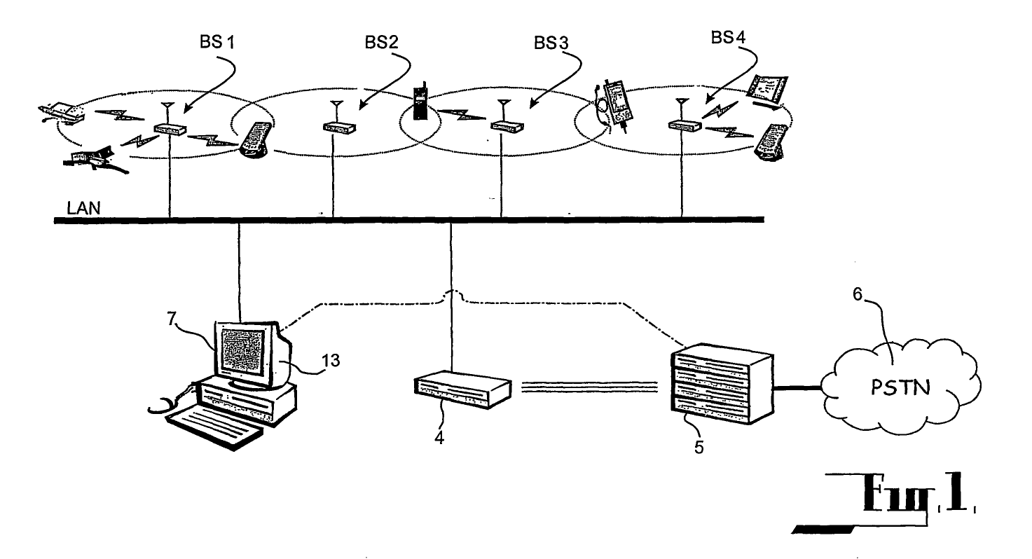

For the purposes of describing the present invention, consider network 100 with bluetooth units in a normal office environment. This is illustrated in FIG. 1

The network 100 includes a number—in this embodiment four—Bluetooth base stations, BS1, BS2, BS3, BS4, which are located throughout an office environment. Each base station can communicate with other Bluetooth units within its signal range—including the other base stations—in a known manner. Other Bluetooth units may include, for example mobile phones, and PDA's. When in communication with each other, the units form a piconet as described in the description of the prior art.

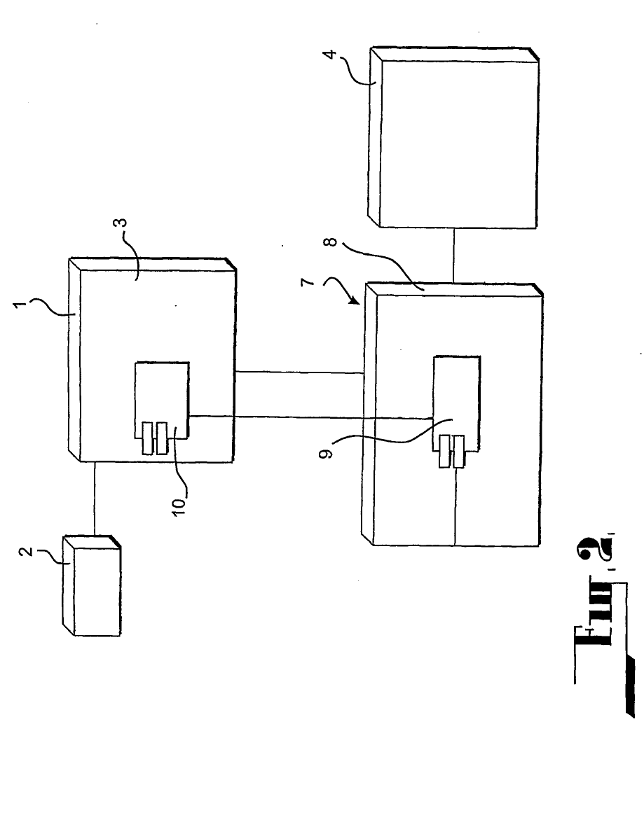

FIG. 2 illustrates schematically some of the components of the network as relevant to the present invention.

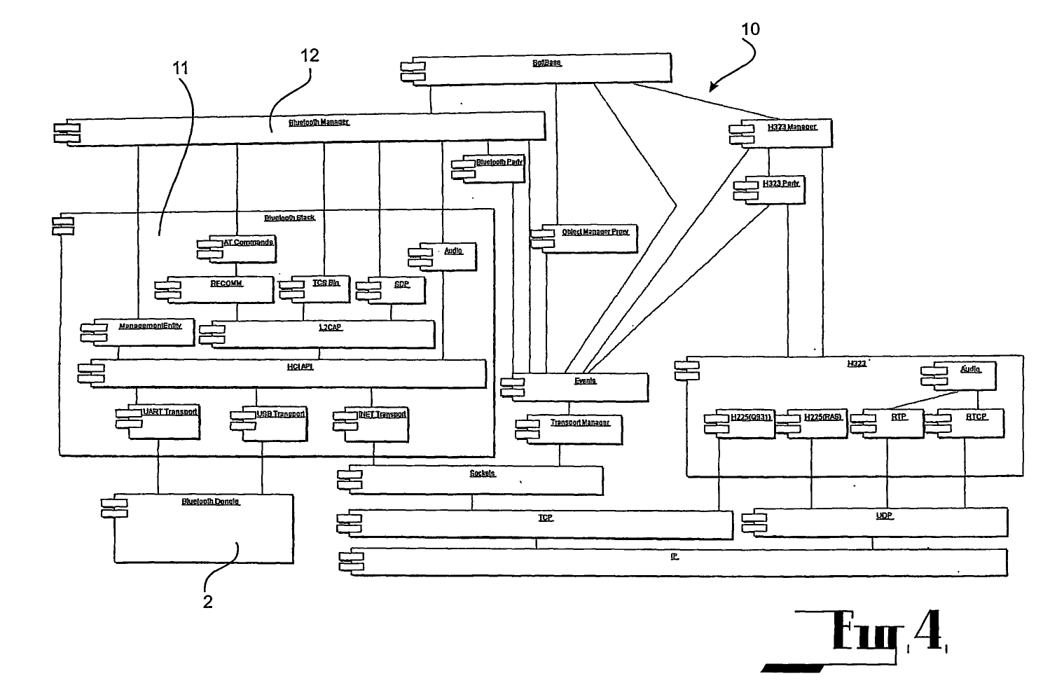

Each base station 1 comprises a so-called “dongle” 2 plugged into an interface of a conventional personal computer 3 and coupled to components necessary for operation of the base station. These components are commonly referred to as the “softbase” 10, and are illustrated schematically in FIG. 4, which is a schematic stack of the components, with lines indicating appropriate communication between the relevant components. These components include the Bluetooth stack components 11, a manager 12, an H323 stack (whose function is equivalent to that discussed in relation to the service platform 9 below), an Object Manager proxy which manages system information communication with the service platform 9 (by means of its Object Manager), a Transport Manager manages all communication with the service platform 9 and other softbases.

Bluetooth devices, as well as other components that—in addition to the components mentioned above, in so far as they are not relevant to the present invention, need not be described in any further detail herein. Other Bluetooth devices, such as phones, and PDA's, include similar components, as, from the point of view of their operation as Bluetooth devices are concerned, their operation and components provided for their operation, are the same.

The base stations 1 are also coupled together to form a Local Area Network (LAN) along with a telephony gateway 4, which is coupled to a PABX system 5, and ultimately to a Public Switched Telephone Network (PSTN) 6. The use of LANs, telephony gateways, PABX's and PSTN's is well known to persons skilled in the art, and, insofar as it is not relevant to the present invention need not be described in any further detail herein. This network is illustrated schematically in FIG. 1.

Each base station 1 communicates with other mobile units/terminals within its range of operation. In this sense it is a cellular system with analogies to known cellular radio systems such as GSM and CDMA. In this network, the average cell size is 10 m in radius, and a maximum of 100 m.

The network also includes a network controller 7.

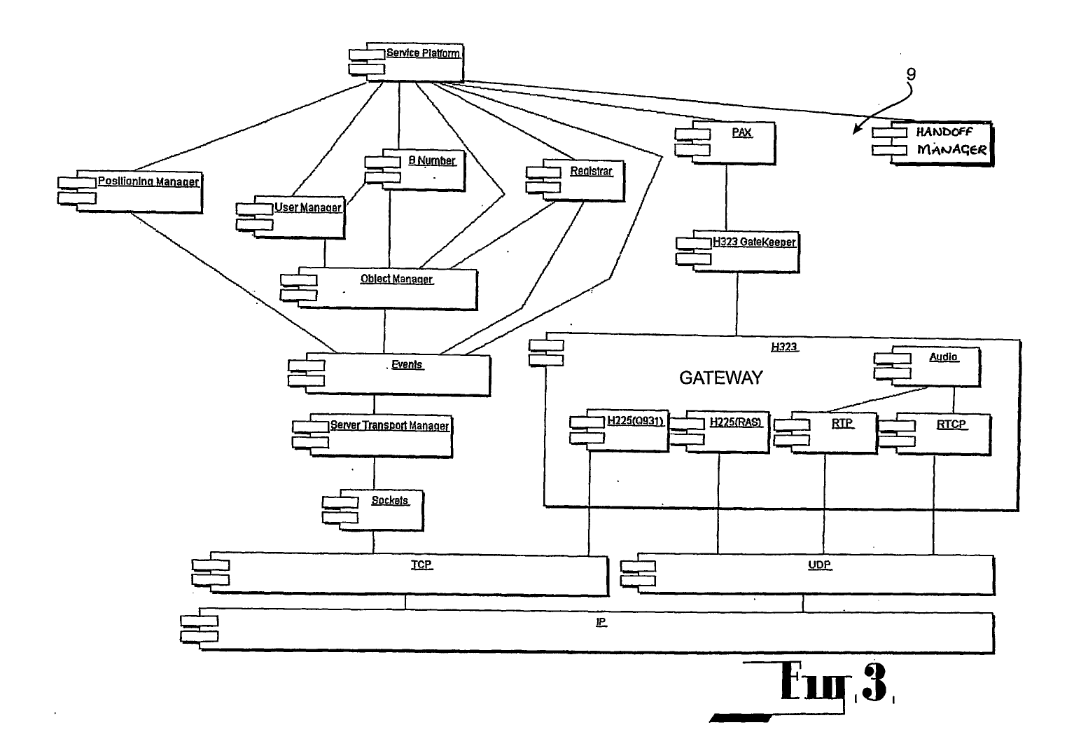

The network controller 7 comprises a number of components, which are illustrated schematically in FIG. 2. In particular, the controller includes a server 8 and a service platform 9. The components for the service platform 9 are illustrated schematically in FIG. 3, which is a protocol stack of the various components. The platform 9 includes an Object Manager, an H.323 Gateway a positioning manager, a handoff manager, a user manager, a PAX, a Registrar, and a B-number, as well as other components.

The following components have the following functions:

Object Manager—manages all system information for base stations, mobile units, other terminals and users.

H.323 Gateway—manages call set up and routing, and allows voice data to be transmitted over the IP layer.

Positioning Manager—monitors base stations' positions, manages coverage and capacity, tracks mobile stations.

Handoff Manager—manages the handoff process.

User manager—manages user profiles.

PAX—manages call set ups to/from the PBX/PSTN, and deals with the H.323 Gateway.

Registrar—deals with terminal registration and authentication, and keeps track of which base station is serving which mobile unit/terminal.

B-number—processes called numbers to check for validity and convert to routing numbers.

The means of communication between the various components is illustrated by the lines in FIG. 3. The Server Transport Manager manages communication with the softbase 10.

Unless otherwise discussed, the functions performed by the various components are known to persons skilled in the art, and insofar as they are not relevant to the present invention, need not be described in any further detail herein.

When Bluetooth devices are in communication with each other they have established a piconet. As mentioned above, up to eight Bluetooth devices can form a piconet, but, for clarity, the operation of only two devices is described. One Bluetooth device BS1 is a base unit (or base station), while the other is a mobile unit MS1. The communication between the two has been established in the usual way in accordance with the Bluetooth protocols. The base station BS1 is the Master unit, and the mobile station MS1 is the slave unit.

Other Bluetooth devices, such as phones, and PDA's, include similar components, as, from the point of view of their operation as Bluetooth devices are concerned, their operation and components provided for their operation, are the same. During the course of communication if the base station establishes that the quality of the communication links between the base station BS1 and the mobile station MS are below a predetermined level—for example by measuring Received Signal Strength (RSSI)— then it is necessary to transfer communication from the Base station BS1 to another base station BS2 which will provide better communication quality i.e. to perform a handoff.

Each mobile station includes a Link Manager (not shown) that operates in accordance with the Link Manager protocol mentioned above in the preamble of the specification. Each base station includes a Link Manager (not shown) and a Host Application (not shown). The Base station Host Application, and the Base Station Link Manager communicate by means of HCI messages, while communication between the Link Managers for the Base Station and the Mobile Station uses LMP messages. The messages used in the present application are detailed below. These are known Bluetooth components, and their operation and role in managing communication between Bluetooth devices is also known and, as such, need not be described in any further detail herein, except in so far as is necessary to describe the present invention.

In order to perform handoff, the first Base Station BS1 must establish which other Bluetooth device can be used as the new Base Station BS2. It may therefore be useful to determine the position of the mobile station.

The two most critical elements in determining handoff are determining the best time to perform the handoff, and selecting the appropriate target base station i.e. that to which the mobile station is going to be transferred. Part of this process will be identifying the location of the mobile station, and thereby being able to quickly identify potential new base stations to which to transfer the mobile station. In conventional cellular radio telephone networks handoff is performed on the basis of received signal strength indication (RSSI). However, a single RSSI value gives no indication of the location of a mobile station. In some standards, absolute positioning can sometimes be determined—for example, in the case of an emergency—using a triangulation technique. In general, this is not suitable for use in a handoff process.

Thus, when quality between the Mobile Station and Base Station drops below a predetermined level e.g. the RSSI drops below a predetermined level, then the communication between the Mobile Station and the Base Station needs to be transferred to another Base Station. Before initiating a handoff, the receiving Base Station needs to be identified.

The first step in determining which Base Station is to receive a handoff, is to determine the velocity and direction of movement of the Mobile Station.

Briefly, a method for determining ‘a Mobile Station’s position comprises the following steps:

1. Obtaining regular RSSI measurements for every mobile station from as many base stations as possible. Include timing information so as to enable RSSI measurements from different sources to be related in time.

2. Calculating the mobile station's position using the RSSI measurements.

3. Estimate the mobile station's velocity (speed and direction) from previous position information.

This allows the following:

1. Using this positional information, to build up an historical picture of the routes taken by the terminal.

2. Using the historical data, to predict the routes most likely to be taken by the terminal.

3. Using a combination of RSSI and positional information, to determine when to perform handoff.

4. Using a combination of RSSI and route prediction information, to determine the best target cell for the handoff.

Now consider the network (FIG. 1) that includes the four base stations BS1, BS2, BS3, and BS4 in an office environment. Within that network, there are also a number of mobile units or stations—in this embodiment four—MS1, MS2, MS3 and MS4.

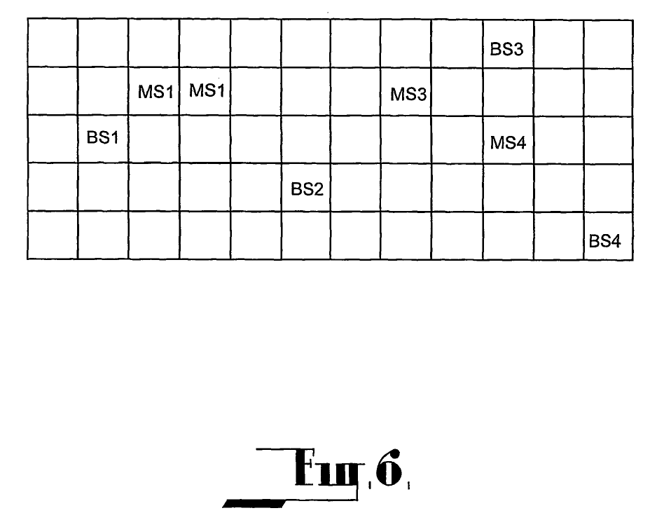

To model the environment e.g. office, the environment is divided into rectangular grid squares 18 using a grid system 17— illustrated in FIG. 6.

Details of the environment are provided to provide information on the size and shape of the area as well as information on any walls, or other obstacles that may provide attenuation for the radio signals to and from the base stations. This information can be supplied in any suitable form, but in the embodiment described herein, this may be in the form of a so-called CAD file, i.e. as produced in computer-aided design software packages. This has the advantage that such files may be readily available, as they may have already been drawn up when the environment was designed.

The office environment is then divided into the grid 17, including grid squares 18.

Within this environment, there will be a subset of these grid squares 18 which may be used as base station locations. Usually, base stations have a substantially circular radiation or coverage pattern. However, significant obstacles e.g. office walls, can substantially attenuate the signal from the base station, and it is therefore possible, knowing the layout of the environment, to estimate areas of attenuation, and where the base station coverage is going to be less than “perfect”. It also possible to take account of the power of each base station, as the power of the base station will effect the range of coverage as well as any attenuation. Typically, the power levels can be discretised so that base stations are identified as having coverage with a radius of up to 5 m, up to 10 m and so on up to a value of 100 m.

For each grid square 18 (or set of grid squares 18) is data regarding potential connections each Mobile Station can make to Base Stations within its signal range. This data is initially predicted, then updated from historical observed behaviour. Also associated with each grid square 18 is a minimum number of Base Stations that must cover the location, so the expected number of calls to that location can be handled by the system. This can be deduced from historical behaviour and can be predicted using known communications traffic modelling techniques. The system is monitored to ensure these predictions are correct.

The centre of each grid square 18 becomes a possible location from which a Mobile Station may make a connection, with any inaccessible areas flagged out. In addition some grid squares 18 have Base Stations positioned at them. It is assumed that for each grid square 18 we can quickly determine the Base Stations that offer coverage to this location and each base station keeps a list of areas it covers. Also, the position of each Mobile Stations and Base Stations is known and the grid squares 18 they reside in can be quickly determined.

Consider a base station—BS1 in the embodiment described herein—in active communication with a mobile station MS1. It should be remembered that all Bluetooth units can operate as master and slave units—in this embodiment, the base station is the master unit, and the mobile station MS1 is the slave unit.

The base station BS1 measures RSSI information from MS1 (and any other Bluetooth units within it's range—in this embodiment MS1 and MS2). Similarly, all the other base stations BS2, BS3, BS4 within the network are operable to carry out similar measurements for other Bluetooth units within its range. The base station BS1 is also operable to synchronise the clock information between the base station BS1 and the mobile station MS1, as is known, as RSSI measurements between the mobile station and each base station are not all done at the same time, it is necessary to incorporate time information for the interpolation. The RSSI measurements may be smoothed over time to minimise multi-path effects and temporary propagation path disturbances. This information is stored in a Measurement Database (not shown). The Measurement Database is provided in the positioning manager.

When a Mobile Station MS1 is engaged in an active connection with the Base Station BS1, then the measurements are reported when they change more than a configurable amount. If the RSSI falls below a configurable threshold, the handoff manager is informed and a handoff process is initiated. The request to perform a handoff is then sent from the network controller 7 to the Base Station that initiates the handoff. If the Mobile Station MS1 is idle, it is polled regularly and the measurements made. Each Base Station makes a request of each Mobile Station, for example, by making a brief ACL connection. The Mobile Station performs the request, and sends the information back to the Base Station which then reports the measurements to the network controller 7, and waits for the next request from another Base Station, and so on. The polling periods are determined by the network controller 7 and passed to each Base Station, which then performs the requests to the Mobile Stations in turn. Synchronisation information from each Base Station is reported to the Measurement Database so that interpolation can be performed. The interpolation is discussed further below. The information reported allows measurements to be synchronised to within 100 ms.

This means the Measurement Database gets a regular stream of measurements for each Mobile Station from all Base Stations within range of the respective mobile station.

Similarly, the network controller 7 is operable to instruct the Base Stations to request the Mobile Stations within their reach to take measurements for the RSSI and time synchronisation information for all Base Stations in its range, and report, via the respective Base Station to the network controller 7. This information is also stored in the Measurement Database. The RSSI measurements are smoothed over time to minimise multi-path effects and temporary propagation path disturbances.

On the basis of the RSSI measurements taken by each Base Station, for each Mobile Station within its reach, the system is able to determine the positions of the Mobile Stations within the network at any particular point in time. The position of the Mobile Stations are estimated by the process of the following:

1. Interpolating the readings from each base station so as to provide an estimated measure of the distance of each mobile station from each base station at a synchronised point in time.

2. Applying the synchronised measurement data with base station position information to determine estimates of Mobile Station locations using a triangulation method. Three distance measurements from fixed position base stations are required to triangulate its position. Due to the fluctuations in RSSI readings, a greater number of readings (correlating to distance estimates) are used and a standard non-linear least squares fitting algorithm applied. The algorithm uses a sum of squares error function and finds the Mobile Station position that minimizes this function. The base station positions can be determined, for example, by hand, by GPS readings, or by any other suitable means.

3. Estimation of the velocity and direction of travel of each mobile station, by using the positions of the Mobile Station at different points in time and averaging them over a small time window.

4. Define the residual error for the Mobile station and each Base Station providing a RSSI reading as the value of the absolute difference between the distance estimate between these two devices and the calculated distance using the co-ordinates of the Base Station and the Mobile station position estimates. Over time, if a residual error is consistently significantly large then the readings from the Base Station to the Mobile station location are flagged as being unreliable. This may occur for such reasons as the presence of a significant obstacle. RSSI measurements between the Base Station and a Mobile station within a predefined radius of this location (based on past Mobile station travel direction and velocity measurements) are not included in any future calculations. By removing these outlier readings the Mobile station location estimates will be more accurate.

5. Reporting of results to the Measurement Database.

By carrying out these measurements, it is possible to build up a “map” of how mobile stations roam around the environment. Within an office environment there are usually a number of major thoroughfares, a number of minor thoroughfares and multiple feeder pathways—for example, from an individual's desk to a main route through the office. The routes taken by Mobile Stations are recorded over time and a traffic density map is built up. This traffic density map is overlaid on the base station coverage and attenuation maps to build up path probability statistics, i.e. the system is able to determine the probable paths that a Mobile Station will take. If paths change due, for example, to a reorganisation of the office space, then the system will automatically adjust its information. While there will be a period of time when actual paths do not match predicted paths, this period can be fine-tuned by controlling sensitivity weightings that shape the delay between new and old data taking precedence.

Recording time information allows a further refinement to the path prediction algorithms. This supports time of day phenomena like coffee breaks, regular meetings and start/end times being identified and used to assist the accuracy of the path prediction. For example, at the end of the day, the chances are that most of the traffic will be from individual Mobile Stations moving towards the exit door of the office.

From this information, it is possible to identify path segments that Mobile Stations have a very high probability of following from start to finish. Thus any Mobile Station journey consists of a number of segments. A path segment is a path from one grid square to an adjacent grid square. At the junction of segments, the Mobile Station will follow one of several possible segments, and the system must then determine the probabilities of which of the segments the mobile Station is likely to follow. The probability that a Mobile Station will choose a specific segment is made up of two elements. The first element is the probability derived from the total Mobile Station population behaviour at that intersection. The second element is the probability derived from the behaviour of that specific Mobile Station at that intersection in the past. It is therefore necessary to derive information about an individual Mobile Station's probable behaviour, as well for the whole population of Mobile Stations.

Just as the probability map for the whole Mobile Station population is built up, so is the probability map for each individual Mobile Station. The individual probability will usually have a higher weighting than the general one, thus supporting better prediction when a mobile station breaks away from the pack. The obvious example of this occurs when a Mobile Station consistently takes what is generally a low probability segment because that is, for example, the route to their desk. In this situation, the system should give the highest probability to the desk branch for this specific Mobile Station, but give the highest probability to the thoroughfare path for all other terminals.

Predicting the path of a mobile station involves combining the following elements.

The mobile station's current position and path segment;

Its velocity vector; and

For each potential path segment:

Individual Path Probability

Network Path Probability

Cell capacity probability

Time of day weighting

Handoff required weighting

Velocity vector weighting

The time period between performing position estimates and path predictions is configurable but will normally be less than 1 second. Different configuration values may be used for terminals engaged in a call and for those that are idle.

The method for storing the path segments, the probability of an individual terminal following a specific path segment and the corresponding general probability must minimise storage space and provide fast access if the required throughput is to be supported.

The handoff is performed as follows:

When the link quality between a Mobile Station and Base Station drops below a predetermined level e.g. the RSSI drops below a predetermined level, then the communication between the Mobile and Base Station needs to be transferred to another base station. Before initiating the handoff, the receiving Base Station needs to be identified.

Firstly, the first Base Station BS1 must establish which other Bluetooth device can be used as the new Base Station BS2.

The method by which of the possible Bluetooth units is to be used as the new Base Station is discussed below.

The first step in determining which Base Station is to receive the handoff is to determine the velocity and direction of movement of the Mobile Station. This has been described above.

Once a Mobile Station's probable path has been determined, then, from knowledge of the positions of the Base Stations, it is possible to determine those Base Stations i.e. a set of base stations to which the Mobile Station may connect.

Having determined the velocity information for all the Mobile Stations, a bipartite graph is created to represent the current state of the system with the set of Base Stations forming vertices of one set of the graph and the set of Mobile Stations forming the other. An edge of the graph represents a current or potential connection from a Mobile Station to a Base Station i.e. it represents data transfer.

Having created the bipartite graph, weights are applied to the edges. A technique for determining these weights is detailed below.

Having created the weighted bipartite graph, a maximum matching whose sum of edge weights is maximised is now determined. This is referred to in the art as solving an “Optimal Assignment Problem”. The use of bipartite graphs and ways to find a maximum (weighted) matching in bipartite graphs is well known, and is described in “Graph theory with Applications” by Bondy J. A., and Murty U. S. R; Elsevier, North Holland 1976. One way of finding maximum weighted matching is to use the known Kuhn-Munkres algorithm.

Using this scheme will yield a reallocation of base stations that are likely to follow the intended paths of the Mobile Stations in a high number of cases. Also the number of extra handoffs required to keep all Mobile Stations connected and having sufficient Link Quality will be kept to a minimum.

The output of the Optimal Assignment problem is a set of edges. The edges in the solution can be compared to the edges representing the current connections to determine the handoff sequence. These edges represent SCO connections that could be made from the Mobile Station set to the Base Station set. These can either be determined either from a list associated with the mobile's grid position of base stations a mobile station could connect to, or by making short ACL pings from the Base Station to the Mobile Station to determine which Base Station can “see” the Mobile Station, and which cannot. Edges not in the original graph represent connections that should be made. Edges of the original graph not in the edge set represent connections that need to be broken. By looking at the edge connections to each Mobile Station, the handoffs and new connections that need to be performed can be determined.

Determination of the weighting function can use the following:

1. Significantly high weights are assigned to the current Mobile Station to Base Station active connections as the system will only want to handoff a Mobile Station to a new Base Station if it is necessary in order for all Mobile Stations to be connected. Similarly for a Mobile Station that is connected to a. Base Station that requires handoff, a significantly low weight is assigned.

2. For other possible connections for each Mobile Station, the probable path the Mobile Station will take from the current location to a fixed distance is determined. The distance, eg. 20 meters, is made greater when the system isn't that busy and less when the system is busier. This is to restrict the calculations required. The path is made up of segments that represent travel from one grid square to another—as mentioned above.

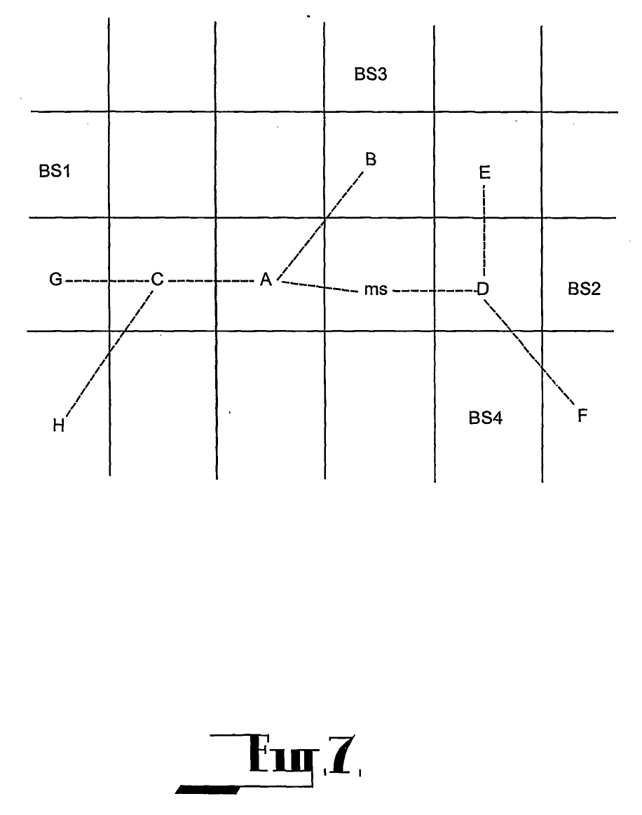

3. Weights, or rankings, are associated with each segment based upon the number of times the Mobile Station has travelled from the current grid square to another divided by the total number of times the Mobile Station has moved from the current grid square to another. Thus these weights are effectively probabilities that the segment will be used. One possible way to calculate the weights is to look at each of the segments in turn and calculate the probability the Mobile Station will arrive at each of its possible destinations. At each step probabilities are calculated for the most likely path, with probabilities associated with edges between the Mobile Station and Base Station on least likely paths not refined. An example is given in FIG. 7. These weights are then assigned to corresponding edges in the graph.

4. Finally the edge weights are adjusted by a given factor that represents some secondary objective depending on the application. For example it it is wished to use as few base stations as possible then a higher factor is associated with edges to base stations currently connected to a Mobile Station than edges associated with base stations which aren't currently utilized.

In FIGS. 7A, B, C, D, E, F, G and H represent grid squares in the grid system that a Mobile Station (MS) can move to. At A the Mobile Station can then move to grid squares B, C or back to its current position.

At D the Mobile Station can move to E, F or back to its current position. At C the Mobile Station travels to G or H or back to A. Say it is wished to predict the Mobile Station path up to 3 grid squares ahead.

All of the Base Stations in FIG. 7 cover the current Mobile Station (MS) position. BS2 and BS4 also cover positions D, E and F; BS1 also covers positions A, C, G and H; and BS3 also covers A and B. Say the Mobile Station (MS) has a 0.9 chance of travelling from its current position to A and a 0.1 chance of travelling to D. If arriving at A, the Mobile Station has a 0.6 chance of travelling to C, a 0.3 chance of travelling to B and a 0.1 chance of returning to its current position. Arriving at C the Mobile Station has a 0.7 chance of travelling to G, a 0.3 chance of travelling to H and a 0.0 chance of returning to A. Arriving at D the Mobile Station has a 0.8 chance of travelling to E, a 0.1 chance of travelling to F and a 0.1 chance of returning to its original position. The most probable path for the Mobile Station to follow is to travel to A then C then G. Edge weights are calculated as follows:

Since the Mobile Station is unlikely to travel to D the weight 0.1 is assigned to the edge corresponding to the possible connection between Mobile Station and BS2 and the edge corresponding to the possible connection between Mobile Station and BS4. These weights are not refined since this path is unlikely to be used by the Mobile Station.

Considering the most likely segment, weight 0.315 (0.9*0.3+0.9*0.1/2.0) is assigned to the Mobile Station, BS3 possible connection and 0.045 (0.9*0.1/2.0) to the Mobile Station, BS1 connection. The next most likely route that involves the Mobile Station travels to G after arriving at C is then looked at. 0.162 (0.9*0.6*0.3) for the C, H segment and 0.0 (0.9*0.6*0.0) for the C, A one is then added. Since this is the limit at which it is wished to calculate the predictions 0.378 (0.9*0.6*0.7) is added to the Mobile Station, BS1 connection for the C, G segment. Thus the total weight for the Mobile Station to BS1 connection is 0.585 (0.045+0.162+0.0+0.378).

Say there are two Base Stations operating at full capacity (i.e. with three connections) with Mobile Stations connected to each of the Base Stations. If two Mobile-to-Base Station connections need to be swapped from one base station to the other, then it is necessary to involve a third Base Station to achieve this. This is because if only two Base Stations were involved then at some stage the capacity of one of them would need to be exceeded. For example, consider a network with three Base Stations BS1 to BS3, and six Mobile Stations MS1 to MS6, with the following current connections:

BS1-MS1; BS1-MS2; BS1-MS3, and BS2-MS4; BS2-MS5; BS2-MS6.

Consider the set of base stations that are currently operating at full capacity. Create an unweighted bipartite graph as follows:

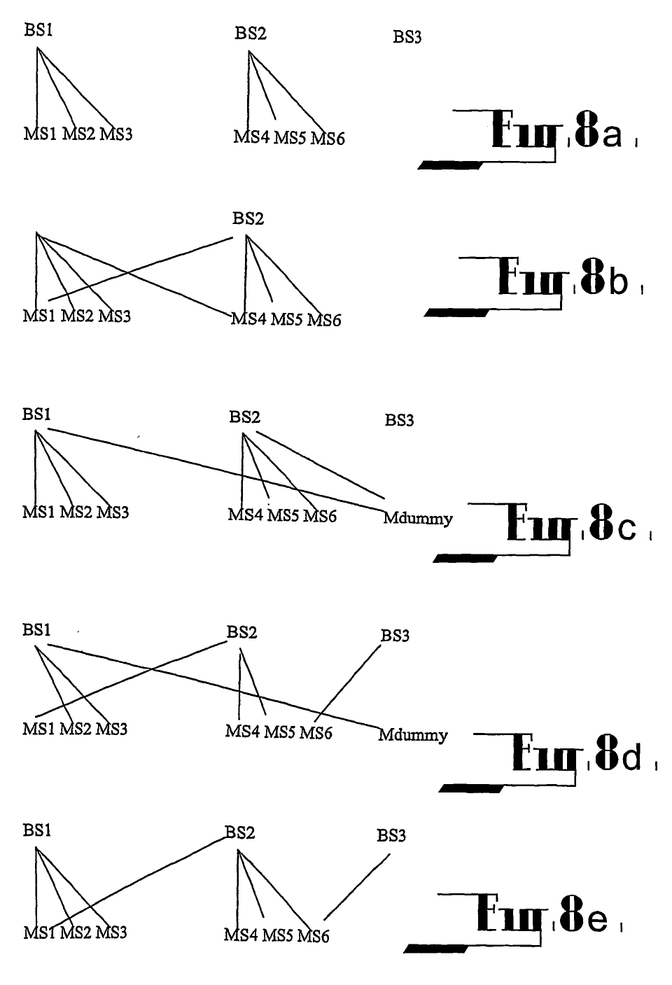

Let one set of the vertices be the set of Base Stations operating at full capacity of three connections and the other be the set of Mobile Stations currently connected to these Base Stations. Add edges corresponding to the current connections between the two sets. This is illustrated in FIG. 8A. Also add an edge for each new connection proposed by the output of the Kuhn-Munkres algorithm, for example this could be handing off MS1 to BS2 and MS4 to BS1—see FIG. 8B. Then if a cycle exists in the graph (this can be checked in O(n), where n is the number of vertices in the unweighted bipartite graph) then it is not possible to perform the handoffs specified, using just the two base stations without exceeding their capacity specifications.

In this case do the following:

1. Add a dummy mobile station vertex M_{dummy} to the original graph and connect this vertex by edges to each Base Station vertex corresponding to the vertices in the cycle of the above unweighted bipartite graph. Give the edges weight zero (FIG. 8C).

2. Reapply the Kuhn-Munkres algorithm to the original graph. The solution to this is illustrated in FIG. 8D.

3. Repeat this procedure until a solution not having the above cyclic property is created or a time limit is exceeded. Excluding the M_{dummy}, yields the solution—see FIG. 8E.

If the time limit is exceeded in step 3 then a call may have to be dropped as there is no way of determining connections to keep all Mobile Stations connected within the specified time limit. In this case we drop the weakest connection (specified by current RSSI values) and perform the other handoffs.

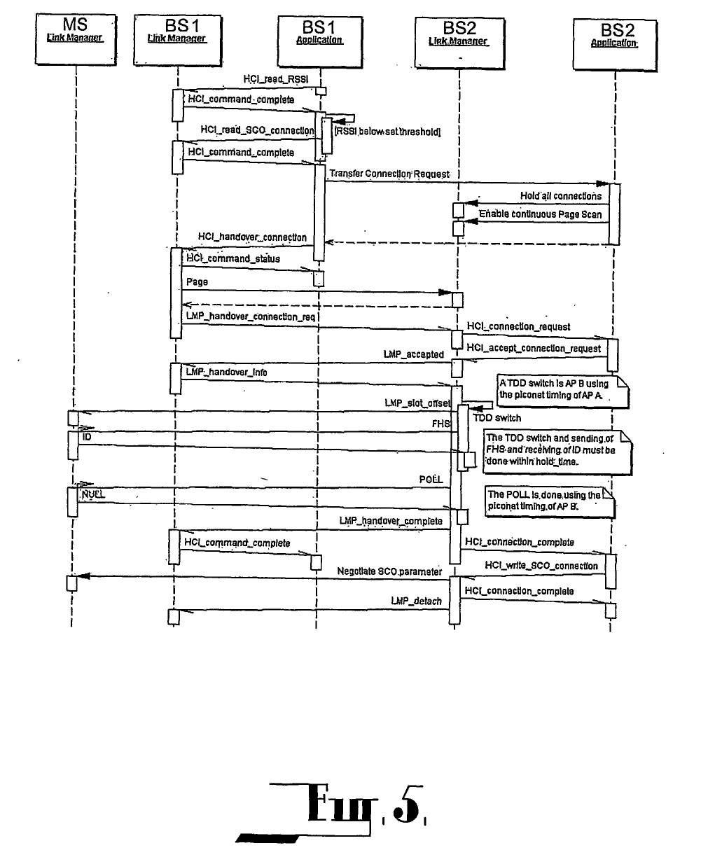

Once the first Base Station BS1 has determined the second Base Station BS2, then the first Base Station BS1 must transfer the communications link to mobile station MS to the second Base Station BS2; The handoff collaboration between the two Base stations BS1, BS2 and the mobile station MS is illustrated in FIG. 5, and is described below.

In order to perform handoff, new messages are needed, in addition to the standard, known messages detailed in the Bluetooth core specification, which, in so far as they are already known and are not relevant to the present invention need not be described in any further detail herein.

The new messages required, can be detailed as follows:

LMP_Handover_Connection_Req

This message is similar to LMP_host_connection_req. It is sent from the first base station BS1 and is used to request the receiving base station BS2 to accept a handoff of the Mobile Station into its piconet. It contains the Bluetooth Address of the Mobile Station MS.

The receiving Base Station BS2 should respond with an LMP_accepted or LMP_not_accepted message.

LMP_Handover_Info

This message is used to inform the receiving Base Station BS2 of the AM_ADDR for the Mobile Station MS and the amount of time, in slots, it has to handover the Mobile Station. It should also contain the supported features of the Mobile Station MS.

The hold_clk represents the value that the first Base Station BS1 clock will be when the receiving Base Station BS2 finishes the handoff process.

Note: Encryption must be disabled/turned off before the handover process is started.

LMP_Handover_Complete

This message is used to inform the first Base Station BS1 that the handoff of the Mobile Station has been successful or unsuccessful. If successful it is safe for the old Base Station BS1 to remove all information related to the Mobile Station MS. If unsuccessful the first Base Station BS1 can retry the process by sending the LMP_handover_connection_req again.

HCI_Handover_Connection

This HCI command is the start of the handoff procedure. It contains the connection_handle of the Mobile Station MS i.e the Slave device as well as the Bluetooth Address and Page information of the receiving Base Station BS2 i.e. the new Master.

The following messages are known messages for communication between Bluetooth units and are used in the handoff process. However, they may have a new field/parameter added to them as set out below:

HCI_Connection_Request

This HCI event is sent when an LMP_handover_connection_req is received. It contains the Bluetooth Address of the Mobile Station MS —with the Link_Type parameter—to set a new value for the handoff, when used as a parameter in the already existing HCI_connection_request message.

HCI_Accept_Connection_Request

This HCI command is sent to accept the LMP_handover_connection_req. It contains the Bluetooth Address of the Mobile Station MS. The role is always 0×00 as the receiving Base Station BS1 will always be the Master of the new connection.

HCI_Reject_Connection_Request

This HCI command is sent to reject the LMP_handover_connection_req. It contains the Bluetooth Address of the Mobile Station MS.

HCI_Connection_Complete

This HCI event is sent to indicate the completion of the handoff process. It contains the connection_handle for the Mobile Station MS of the new Base Station, the Link_Type parameter set to the new value for handoff and Encryption_Mode set to the encryption mode of the link before the handoff.

So that the Mobile Station is not aware of the transfer, Channel Identifiers (CID's) must be unique between all potential receiving Base Stations. This limits the number of simultaneous L2CAP connections to 65472 (16 bits of information with the values 0 to 63 reserved).

SCO handles are only used internally to the Link Manager. The SCO handles don't need to be unique if the Link Manager keeps track of the SCO handle value the Mobile Station has recorded as representing the SCO link between it and the Base Station. Internally the Base Station Link Manager's SCO handle just needs to be mapped to the connection_handle passed to the upper layers. The SCO handle, at the LMP level, is used as a common reference to the SCO link between two Bluetooth devices. The Link Manager only uses a SCO handle internally, any reference from upper layers to a SCO link is done via a connection_handle, which is supplied by the Link Manager to the Host Application. If the Link Manager maps a connection_handle to a Bluetooth device and its SCO handle, then the SCO handle value does not need to be unique. The Link Manager will only need unique SCO handles to a Bluetooth device with multiple SCO connections.

Before handoff can begin, the first base station BS1′ must establish which other Bluetooth device can be used as the new base station BS2 i.e. which is to be the receiving Base Station. For example, the second Base Station could a Base Station with a stronger signal strength located between the Mobile Station and the first Base Station. Once the first base station BS1 has determined the second base station BS2, then the first base station BS1 must transfer the communications link to mobile station MS to the second base station BS2. The handoff collaboration between the two Base stations BS1, BS2 and the mobile station MS is illustrated in FIG. 5.

As mentioned above, each Base Station is periodically measuring the RSSI between itself and any Mobile Station to which is in communication with. Other indicators of link quality can also be measured. When this value falls below a predetermined level then handoff is to be performed to the selected receiving Base Station BS2.

In preparation for the transfer, the timing information for the associated SCO channel reads a response to an HCI_read_SCO_connection message from the application of the first base station to the Link Manager of the first base station BS1. This information, along with information about the Mobile Station MS, is sent to the selected receiving Base Station BS2. An HCI_command_complete message it sent back to the Application, when this is done.

The first Base Station then requests a transfer to the receiving Base Station BS2. The connection between the first Base Station BS1 and the receiving Base Station is carried out in a known manner in accordance with the Bluetooth core specification. In this connection, the first Base Station BS1 operates as the master, while the receiving Base Station BS2 operates as the slave. In so far as this means of connection and communication is already known, it need not be described in any further detail herein. The actions that must be performed by the receiving Base Station BS2 in response to a transfer connection request are to hold all current connections, enter a continuos page scan mode, for a quick connection, and prepare to receive an HCI_connection_request from the first Base Station BS1 for the Mobile Station MS to be transferred. When these actions are done then the receiving Base Station BS2 should respond with a positive acknowledgment. If it cannot perform these actions a negative response is required.

On a positive response the Application of first Base Station BS1 sends HCI_handover_connection to start the handover process at the Link Manager level.

The first Base Station BS1 now connects, via a known Bluetooth Page process to the receiving Base Station BS2. This provides the piconet timing information for the first Base Station BS1 to the receiving Base Station BS2. This connection is used for all LMP messages between the two Base Stations BS1, BS2.

The first Base Station BS1 then sends an LMP_handover_connection_request to the receiving Base Station BS2. This message causes the Link Manager of receiving Base Station BS2 to send an HCI_connection_request to its host Application. If the Host Application does not accept this request then it replies with an HCI_reject_connection_request. This will cause the Link Manager of the receiving Base Station BS1 to send LMP_not_accepted to the first Base Station BS1. The first Base Station BS1—in response to the LMP_not_accepted message—sends an HCI_connection_complete to its Host Application indicating the handoff has been rejected.

If the Application of receiving Base Station BS2 accepts the connection, then it responds with an HCI_accept_connection_request, and—in response to this—the Link Manager of the receiving Base Station BS2 sends an LMP_accept message to the Link Manager of First Base Station BS1.

When both the Base Stations BS1, BS2 have agreed to perform and support the handoff; the Link Manager of first Base Station BS1 suspends traffic to all slave devices, including the Mobile Station MS, and will suspend all slave connections, except that to the Mobile Station MS, for a period of time long enough to allow receiving Base Station BS2 to receive LMP_handover_info and perform the handoff of the Mobile Station MS. This suspension period is defined by a parameter/field hold_time in the LMP_handover_info message sent from the first Base Station BS1.

Once traffic is suspended, the first Base Station BS1's Link Manager sends LMP_handover_info to the receiving Base Station BS2. This message contains information about the Mobile Station, and how long the receiving Base Station BS2's Link Manager has to complete the handoff process. After this message has been sent, the first Base Station BS1 does not transmit to any slave, including the Mobile Station MS, until the suspend period has elapsed.

In response to receipt of the LMP_handover_info, the receiving Base Station BS2 schedules the handoff process of the Mobile Station MS as highest priority. If the handoff process is not complete before the suspension period i.e. hold_time, has expired then it shall be aborted immediately and an LMP_handover_complete message is sent to the first Base Station BS1 to indicate that the handoff has failed because hold_time had lapsed.

The handoff process consists of the same LMP messages as describe in the Bluetooth Core specification Part B section 10.9.3 “Master-Slave switch”—as described after the master and slave devices have switched and the new master is transferring the old Master's Slaves into the new piconet. This is described with regard to the present invention below:

The receiving Base Station BS2 sends an LMP_slot_offset message to the Mobile Station MS. This message informs the Mobile Station MS of the difference in the slot boundaries between the first Base Station BS1's piconet and the receiving Base Station BS2's piconet.

The receiving Base Station BS2 uses the timing parameters from its connection to the first Base Station BS1, to temporarily assume the role of Master of the first Base Station's piconet and send a Frequency Hopping Scheme (FHS) packet to the Mobile Station MS. The FHS packet contains the information for the receiving Base Station BS2's piconet as described in the Bluetooth Core specification section Part B section 4.4.1.4.

The Mobile Station MS should respond to the FHS packet with an ID packet. The ID packet identifies the responding device—in this case, the Mobile Station MS. If not, then the FHS packet is sent repeatedly until the Mobile Station MS responds correctly or until the hold_time expires.

On receipt of the ID packet, the receiving Base Station BS2 transmits a POLL packet using its own piconet timing parameters.

The Mobile Station MS should respond with a NULL packet confirming its switch to the new piconet parameters. If not, then the process loops back to the above process after the LMP_slot_offset was sent.

In this process the communication follows a Time Division Duplex (TDD) scheme where two communicating devices e.g. a master and a slave alternatively transmit. Normally, a master will transmit in an even slot and receive in an odd slot, and the slave vice versa. Because the receiving Base Station BS2 is also a slave of the first Base Station BS1 (which is also master of the Mobile Station MS), it needs to preform a TDD switch to be able to communicate with the Mobile Station MS when it is transferred into the receiving Base. Station's piconet.

The reception of the NULL packet confirms that the Mobile Station has been transferred onto the receiving Base Station BS2's piconet. The receiving Base Station's Link Manager shall send LMP_handover_complete message to the first Base Station BS1 and an HCI_connection_complete message to the receiving Base Stations' Application indicating success.

When the first Base Station BS1 receives the LMP_handover_complete message indicating success, it responds by sending an HCI_command_complete message to its Application and cleans up any connection information related to the Mobile Station. This clean up process is carried out by the Application.

If an audio connection was transferred to the receiving Base Station BS2 as part of the handoff, then, when the HCI_connection_complete message is received by the Application of the receiving Base Station BS2, then, in response, it sends an HCI_write_SCO_connection message to inform its Link Manager of the SCO connection.

When HCI_write_SCO_connection is received the receiving Base Station's Link Manager shall renegotiate the SCO connection timing parameters to fit within the receiving Base Station BS2's piconet. When this negotiation is complete the Link Manager sends an HCI_connection_complete containing the connection information for the SCO connection to the Mobile Station MS. If the negotiation fails then the HCI_connection_complete indicates the reason for the failure and the Application for the receiving Base Station BS2 will either disconnect the Mobile Station MS or restart the handoff procedure.

An LMP_detach message should be sent to the first Base Station BS1 when the handoff has been successful or if the handoff attempt is aborted/failed. This severs the connection between the receiving Base Station BS2 and the Mobile Station.

Thus, Handoff is performed.

It will be understood that variations are possible within the scope of the present invention. For example, other path prediction methods could be used. Edge weights could be allocated on the basis of whether a mobile station moves towards or away from a base station. This can be determined from successive RSSI readings.

Other mobile station velocity determination techniques could also be utilised.

The claims defining the invention are as follows:

1. A method for determining information regarding a mobile terminal's movement within a wireless network including a plurality of fixed and mobile terminals, the method comprising the steps of: measuring synchronised Received Signal Strength Information (RSSI) measurements at, at least, two different points in time from at least three fixed terminals for a mobile terminal moving within the network; interpolating the synchronised measurements to provide an estimate of the distance of the mobile terminal, from each of the at least three fixed terminals, at each different point in time; determining an estimated position of the mobile terminal, at each different point in time, from the estimated distances of the mobile terminal from each of the fixed terminals; and determining the mobile terminal velocity by dividing the distance between the positions of the mobile terminal at the two different points in time by the time interval between the two different points in time.

2. A method as claimed in claim 1, wherein the estimated position is determined by triangulation.

3. A method as claimed in claim 1 or claim 2, wherein the method further includes the step of carrying out a plurality of determinations of the estimated position of the mobile terminal and applying a non-linear least squares fit algorithm to the triangulation step.

4. A method as claimed in claim 3, wherein the non-linear least squares fit algorithm includes the step of deriving the sum of squares error function and determines the mobile terminal position that minimises that function.

5. A method as claimed in any preceding claim, wherein the method further includes the steps of defining a residual error for the mobile terminal and each fixed terminal, the residual error being defined as the value of the absolute difference between the distance estimate and the calculated distance using the co-ordinates of the fixed terminal and the mobile terminal estimates, determining any residual error values having a value greater than a predetermined level removing any RSSI measurements between the mobile terminal and a fixed terminal within a predefined radius of a location where the residual error values are greater than the predetermined value, from future calculations.

6. A method as claimed in any preceding claim, wherein the method further includes the step of determining the direction of travel of the mobile terminal.

7. A method as claimed in any preceding claim, wherein the method further includes the step of building a map of mobile terminal movement within the network environment.

8. A wireless network comprising a plurality of fixed terminals in communication with one or more mobile terminals roaming within the network, the network including control means operable to determine the velocity of a mobile terminal by measuring synchronised Received Signal Strength Information (RSSI) measurements for the mobile terminal from at least three fixed terminals at at least two different points in time; to interpolate the measurements to provide an estimate of the distance of the mobile terminal from each of the at least three fixed terminals at each different point in time; to estimate a position of the mobile terminal, at each different point in time, from the estimated distances of the mobile terminal from the at least three fixed terminal; and to determine the velocity of the mobile terminal by dividing the distance between the positions of the mobile terminal at the two different points in time by the time interval between the two different points in time.

9. A wireless network as claimed in claim 8, wherein the control means is operable to estimate the mobile terminal position using triangulation.

10. A wireless network as claimed in claim 8 or claim 9, wherein the control means is further operable to provide a plurality of determinations of the estimated position of the mobile terminal and to apply a non-linear least squares fit algorithm to the triangulation step.

11. A wireless network as claimed in claim 10, wherein the non-linear squares fit algorithm includes the step of deriving the sum of squares error function and determines the mobile terminal position that minimises that function.

12. A wireless network as claimed in any of claims 8 to 11, wherein the control means is further operable to define a residual error for the mobile terminal and each base terminal as the value of the absolute difference between the distance estimate and the calculated distance using the co-ordinates of the fixed terminal and the mobile terminal estimates, to determine if any residual error values have a value greater than a predetermined level; and to remove any RSSI measurements between the mobile terminal and a fixed terminal within a predefined radius of a location where the residual error values are greater than the predetermined value, from future calculations.

13. A wireless network as claimed in any of claims 8 to 12, wherein the control means is further operable to determine, on the basis of the measurements, the direction of movement of the mobile terminal within the network.

14. A wireless network as claimed in any of claims 8 to 13, wherein the control means is further operable to build up a map of the mobile terminal movement within the wireless network environment from the velocity and direction of travel information.

15. A wireless network as claimed in any of claims 8 to 14, wherein the control means may include storage means for storage of the velocity and direction of travel information therein.

16. A wireless network comprising a plurality of terminals, the terminals being operable within the network as either master or slave units, and within the network there is provided first second and third terminals in which the first and second terminals are in communication with each other in a first piconet whereby the first terminal is a master unit and the second terminal is a slave unit, the terminals being operable to control a switch in communication between the second and first terminals to communication between the second and third terminals in a second piconet.

17. A wireless network as claimed in claim 16, wherein the first and third terminals are operable to communicate with each other to request and agree transfer of communication between the first and second terminals to communication between second and third terminals, to communicate information regarding the first piconet, and the second terminal, to the third terminal, the third terminal being further operable, upon receipt of the information and agreement to accept the second terminal into the second piconet, to temporarily assume the role of master of the first piconet to enable communication with the second terminal and to provide information regarding the second piconet to the second terminal, the second terminal being operable, in response to the second piconet information to respond to the third terminal and to communicate therewith to transfer the second terminal into the second piconet.

18. A wireless network as claimed in claim 17, wherein communication between the first and second terminals is suspended during transfer of the second terminal to the second piconet.

19. A wireless network as claimed in any of claims 16 to 18, wherein the network is a network of Bluetooth™ units.

20. A method for performing handoff from a first terminal in communication with a second terminal, to a third terminal in a wireless network comprising a plurality of terminals, the terminals being operable within the network as either master or slave units, and within the network there is provided the first second and third terminals in which the first and second terminals are in communication with each other in a first piconet whereby the first terminal is a master unit and the second terminal is a slave unit, the method including the step of controlling a switch in communication between the second and first terminals to communication between the second and third terminals in a second piconet.

21. A method as claimed in claim 20, wherein the method further includes the steps of the first and third terminals communicating with each other to request and agree transfer of communication between the first and second terminals to communication between second and third terminals, and to communicate information regarding the first piconet, and the second terminal, to the third terminal; the third terminal temporarily assuming the role of master of the first piconet to enable communication with the second terminal and providing information regarding the second piconet to the second terminal, upon receipt of the information and agreement to accept the second terminal into the second piconet; and the second terminal responding, in response to the second piconet information, to the third terminal and to communicate therewith, to transfer the second terminal into the second piconet.

22. A method as claimed in claim 21, wherein communication between the first and second terminals is suspended during transfer of the second terminal to the second piconet.

23. A method as claimed in any of claims 20 to 22, wherein the method includes the step of determining the third terminal from the terminals in the wireless network.

24. A method for determining handoff sequencing within a wireless network comprising a plurality of fixed terminals in wireless communication with one or more mobile terminals roaming within the network, the method including the steps of:
determining the probable paths of the mobile terminals within the network;
determining a set of fixed terminals within the network to which the mobile terminals could be in communication therewith;
creating a first bipartite graph with the set of fixed and mobile terminals;
applying weightings to the edges of the first bipartite graph in accordance with predetermined parameters to create a weighted bipartite graph; and
solving an optimal assignment problem for the weighted bipartite graph to derive a second graph having a second set of edges, to determine a new set of connections between mobile and fixed terminals.

25. A method as claimed in claim 24, further comprising the step of comparing the first and second bipartite graphs, whereby edges not in the first graph represent communications links that should be made, and edges in the first, but not in the second, represent communications links that need to be broken.

26. A method as claimed in claim 24 or claim 25, wherein the predetermined parameters include providing high weightings for active connections that should not be broken unless required to allow all mobile terminals to be connected, and low weightings for connections requiring handoff.

27. A method as claimed in any of claims 24 to 26, wherein a further predetermined parameter is the probable path that a mobile terminal may take within the network.

28. A method as claimed in claim 27, wherein the probable path is determined by historical data.

29. A method as claimed in claim 27, wherein the probable path is determined by its velocity.

30. A method as claimed in any of claims 24 to 29, wherein a further predetermined parameter is the number of fixed terminals to be used.

31. A wireless network comprising a plurality of fixed terminals in wireless communication with one or more mobile terminals roaming within the network, the network including a control means operable to determine the probable paths of the mobile terminals within the network, and a set of fixed terminals within the network to which the mobile terminals could be in communication therewith, the control means being further operable to create a first bipartite graph with the set of fixed and mobile terminals, to apply weightings to the edges of the first bipartite graph in accordance with predetermined parameters to create a weighted bipartite graph, and to solve an optimal assignment problem for the weighted bipartite graph to derive a second graph having a second set of edges, to determine a new set of connections between mobile and fixed terminals.

32. A network as claimed in claim 31, wherein the control means is further operable to compare the first and second bipartite graphs such that edges not in the first graph represent communications links that should be made, and edges in the first, but not in the second represent communications links that need to be broken.

33. A network as claimed in claim 31 or claim 32, wherein the predetermined parameters include providing high weightings for active connections that should not be broken unless required to allow all mobile terminals to be connected, and low weightings for connections requiring handoff.

34. A network as claimed in any of claims 31 to 33, wherein a further predetermined parameter is the probable path that a mobile terminal may take within the network.

35. A network as claimed in claim 34, wherein the probable path is determined by historical data.

36. A network as claimed in claim 34, wherein the probable path is determined by its velocity.

37. A network as claimed in any of claims 31 to 36, wherein A further predetermined parameter is the number of fixed terminals to be used.
